(19) United States
(12) Patent Application Publication
(10) Pub. No.: US 2023/0362533 A1
(43) Pub. Date: Nov. 9, 2023

(54) HEADPHONE TYPE SOUND COLLECTOR

(71) Applicant: Hideki WADA, Hiroshima (JP)

(72) Inventor: Hideki WADA, Hiroshima (JP)

(21) Appl. No.: 18/245,300

(22) PCT Filed: Aug. 16, 2021
(86) PCT No.: PCT/JP2021/029909

§ 371 Date: Mar. 14, 2023

(30) Foreign Application Priority Data
Sep. 15, 2020 (JP) 2020-154482

(51) Int. Cl. H04R 1/28; H04R 1/10

(52) U.S. Cl. CPC H04R 1/28; H04R 1/1008

(57) ABSTRACT

The present invention addresses the problem of obtaining a headphone type sound collector capable of selectively amplifying frequencies of sounds that are difficult for people with weak hearing to hear. As the means for solving the above-mentioned problem, the headphone type sound collector 1 of the present invention is a headphone type sound collector equipped with a sound collecting device 100a or 100b on at least either of the left and right sides thereof, the sound collecting device comprising: a sound collecting cover 110a or 110b having a sound collecting face in a parabolic shape for collecting sound; a base member 120 for pivotally supporting the sound collecting cover; and a microphone 130 for detecting sound collected by the sound collecting cover.

### TECHNICAL FIELD

The present invention relates to a headphone type sound collector, and more particularly to a structure for amplifying sound of a specific frequency.

### BACKGROUND ART

There have conventionally been headphone type sound collectors that utilize the sound collection effect obtained by a person placing a hand over the ear so as to cover the auricle.

For example, Patent Literature 1 discloses such a headphone type sound collector that is used when a person with weak hearing watches or listens to television, radio, or the like, or interacts with another person.

### CITATION LIST

### Patent Literature

[PTL 1] Japanese Laid-open Utility Model Publication No. 64-6700

### SUMMARY OF INVENTION

### Technical Problem

However, the headphone type sound collector disclosed in Patent Literature 1 is simply for collecting incoming sounds. In addition, the frequencies of sounds that are difficult for people with weak hearing to hear vary widely. Therefore, for some people, they still have difficulties hearing well even when they use the headphone type sound collector disclosed in Patent Literature 1.

An objective of the present invention is to provide a headphone type sound collector capable of selectively amplifying a sound in a frequency band that is difficult for a person with weak hearing to hear.

### Solution to Problem

The present invention provides the following items.

### (Item 1)

A headphone type sound collector equipped with a sound collecting device on at least either of the left and right sides thereof, the sound collecting device comprising:
a sound collecting cover having a sound collecting face in a parabolic shape for collecting sound;
a base member for pivotally supporting the sound collecting cover; and
a microphone for detecting sound collected by the sound collecting cover.

### (Item 2)

The headphone type sound collector according to Item 1, wherein the sound collecting cover has a sound collecting face in the shape of a portion offset from the center of the parabolic shape.

### (Item 3)

The headphone type sound collector according to Item 1 or 2, wherein the microphone is fixed to the base member.

### (Item 4)

The headphone type sound collector according to any one of Items 1 to 3, wherein the microphone is attached to the sound collecting cover.

### (Item 5)

The headphone type sound collector according to any one of Items 1 to 4, wherein the base member supports one end of the sound collecting cover such that the sound collecting cover pivots about a pivot axis substantially parallel to upward and downward directions of the headphone type sound collector.

### (Item 6)

The headphone type sound collector according to Item 5, wherein the sound collecting cover pivots about the pivot axis such that the angle formed by a surface of the base member and a straight line connecting one end of the sound collecting cover and the other end opposite to the one end thereof varies within a range of about zero degrees to about 90 degrees.

### (Item 7)

The headphone type sound collector according to any one of Items 1 to 6, wherein at least either of the pair of left and right sound collecting devices comprises:
an amplifier circuit for amplifying an audio signal detected by the microphone; and
a speaker driven by the audio signal amplified by the amplifier circuit.

### Advantageous Effects of Invention

According to the present invention, it is able to provide a headphone type sound collector capable of selectively amplifying a sound in a frequency band that is difficult for a person with weak hearing to hear.

### BRIEF DESCRIPTION OF DRAWINGS

FIG. 1 is a diagram showing the external appearance of a headphone type sound collector 1 according to Embodiment 1 of the present invention.

FIG. 2 is a diagram for illustrating the features of the headphone type sound collector 1 shown in FIG. 1.

FIG. 3 is a diagram for illustrating in detail the structure of the sound collecting unit 100b of the headphone type sound collector 1 shown in FIG. 2.

FIG. 4 is a sectional view for illustrating how to use the headphone type sound collector 1 shown in FIG. 2.

FIG. 5 is a diagram for illustrating features of a headphone type sound collector 2 according to Embodiment 2 of the present invention.

FIG. 6 is a diagram for illustrating the parabolic shape that the sound collecting cover 210 of the headphone type sound collector 2 shown in FIG. 5 has.

FIG. 7 is a diagram for illustrating in detail the structure of the sound collecting unit 200b of the headphone type sound collector 2 shown in FIG. 5.

FIG. 8 is a sectional view for illustrating how to use the headphone type sound collector 2 shown in FIG. 5.

FIG. 9 is a diagram for illustrating features of a headphone type sound collector 3 according to Embodiment 3 of the present invention.

FIG. 10 is a diagram for illustrating the offset parabolic shape of the sound collecting cover 310 of the headphone type sound collector 3 shown in FIG. 9.

FIG. 11 is a diagram for illustrating in detail the structure of the sound collecting unit 300b of the headphone type sound collector 3 shown in FIG. 9.

FIG. 12 is a sectional view for illustrating how to use the headphone type sound collector 3 shown in FIG. 9.

### DESCRIPTION OF EMBODIMENTS

The present invention is described hereinafter. The terms used herein should be understood as being used in the meaning that is commonly used in the art, unless specifically noted otherwise. Therefore, unless defined otherwise, all terminologies and scientific technical terms that are used herein have the same meaning as the general understanding of those skilled in the art to which the present invention pertains. In case of a contradiction, the present specification (including the definitions) takes precedence.

As used herein, “about” refers to the range of the following number±10%.

As used herein, “upward and downward directions” refer to the height direction of the wearer wearing the headphone type sound collector, where the upward direction refers to the direction toward the head, while the downward direction refers to the direction toward the foot.

The problem to be solved by the present invention is to selectively amplify a sound in a frequency band that is difficult for a person with weak hearing to hear, and the present invention has solved the above-mentioned problem by providing a headphone type sound collector equipped with a sound collecting device on at least either of the left and right sides thereof, the sound collecting device comprising: a sound collecting cover having a sound collecting face in a parabolic shape for collecting sound; a base member for pivotally supporting the sound collecting cover; and a microphone for detecting sound collected by the sound collecting cover.

Accordingly, when the headphone type sound collector according to the present invention has: a sound collecting cover having a sound collecting face in a parabolic shape for collecting sound; a base member for pivotally supporting the sound collecting cover; and a microphone for detecting sound collected by the sound collecting cover, other configurations of the headphone type sound collector are not particularly limited.

In the following embodiments, however, a headphone type sound collector equipped with sound collecting devices on both the left and right sides thereof will be mentioned as an example.

Embodiments of the present invention will be described below with reference to the drawings.

### Embodiment 1

### Structure of Headphone Type Sound Collector 1

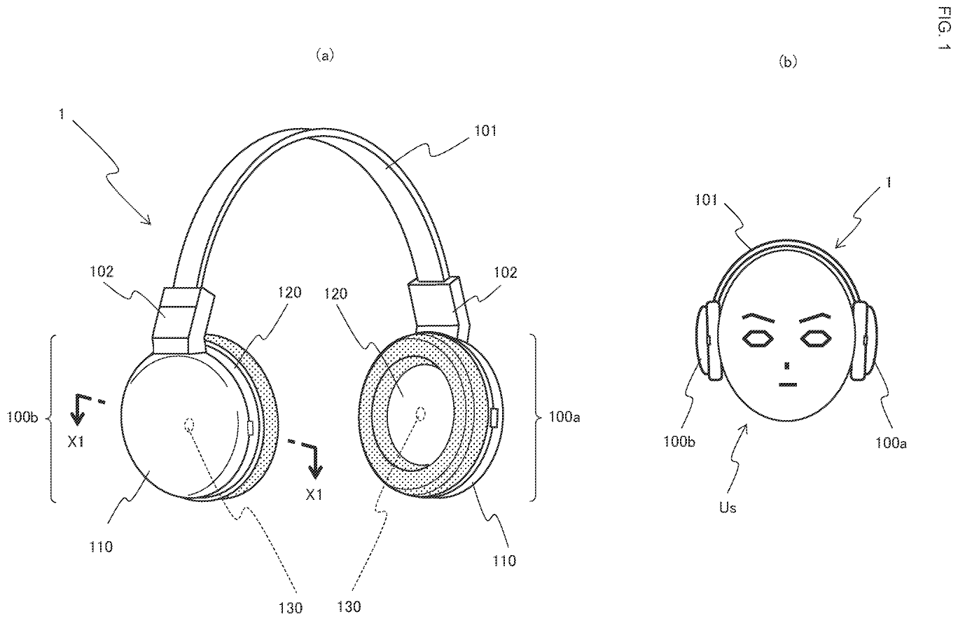

FIG. 1 is a diagram for illustrating a headphone type sound collector 1 according to Embodiment 1 of the present invention, where FIG. 1(a) is a perspective view showing the external appearance of the headphone type sound collector 1, and FIG. 1(b) is a front view of a user Us wearing the headphone type sound collector 1.

The headphone type sound collector 1 according to Embodiment 1 comprises a pair of left and right sound collecting devices (sound collecting units) 100a and 100b. Here, the sound collecting unit 100b on the right side and the sound collecting unit 100a on the left side have the same configuration. Therefore, the sound collecting unit 100b worn on the right ear of the user Us will be specifically described hereinafter.

The sound collecting unit 100b comprises: a sound collecting cover 110 having a sound collecting face in a parabolic shape for collecting sound; a base member 120 for pivotally supporting the sound collecting cover 110; and a microphone 130 for detecting sound collected by the sound collecting cover 110.

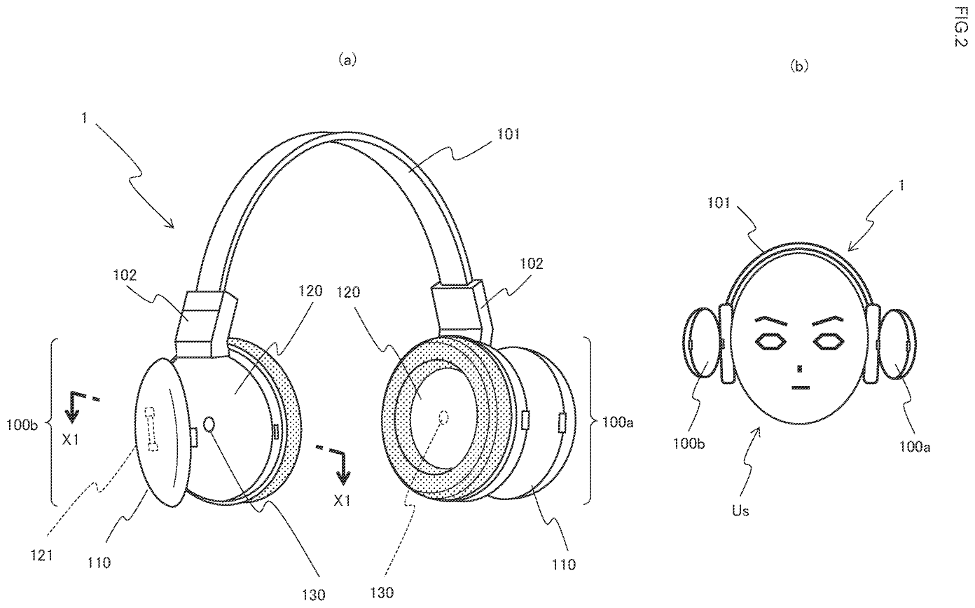

FIG. 2 is a diagram for illustrating the features of the headphone type sound collector 1 shown in FIG. 1, where FIG. 2 (a) is a perspective view showing a state in which the sound collecting cover 110 of the headphone type sound collector 1 is opened, while FIG. 2(b) is a plan view showing a state in which the sound collecting cover 110 of the headphone type sound collector 1 worn by a user Us is open, as viewed from the front of the user.

The sound collecting unit 100b comprises a hinge mechanism 121 for attaching the sound collecting cover 110 to the base member 120 in such a manner to be pivotable based on the pivot axis substantially horizontal to the upward and downward directions. The user Us allowed to manually adjust the rotational position (opening degree) of the sound collecting cover 110 with respect to the base member 120. Accordingly, the structure is such that the frequency of the sound to be collected can be selectively changed by adjusting the opening degree of the sound collecting cover 110. The sound collecting unit 100b may be configured to comprise a driving source (such as a motor) for pivoting the sound collecting cover 110 so as to automatically perform the opening degree adjustment of the sound collecting cover 110.

Hereinafter, the structure of each of the parts that constitute the headphone type sound collector 1 will be described in detail.

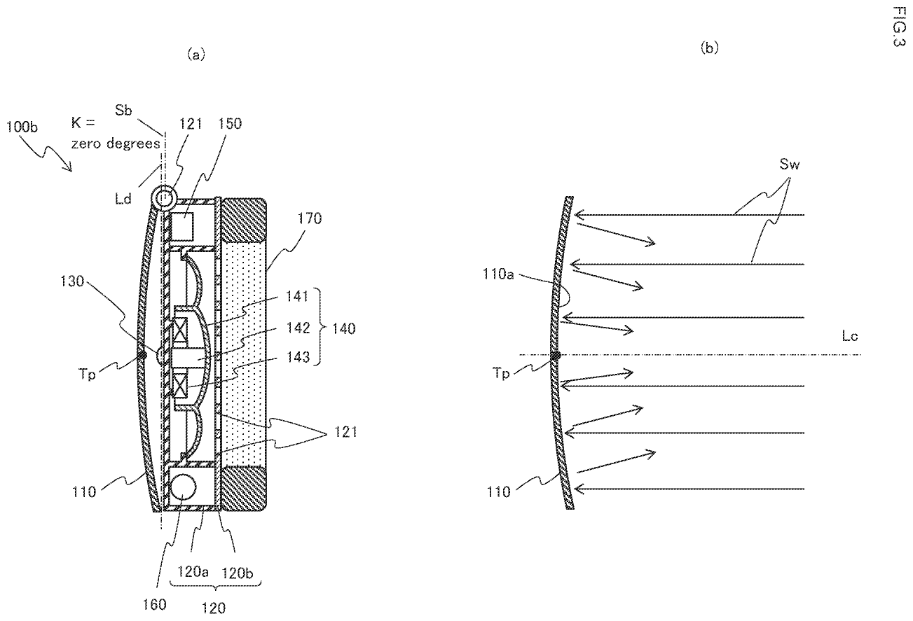

FIG. 3 is a diagram for illustrating the structure of the sound collecting unit 100b of the headphone type sound collector 1 shown in FIG. 1, where FIG. 3(a) is a sectional view taken along line X1-X1 in FIG. 1(a), while FIG. 3(b) shows how sound waves Sw from a direction parallel to the central axis Lc of the sound collecting cover are reflected by the sound collecting cover 110 of the sound collecting unit 100b.

### (Sound Collecting Cover 110)

With regard to the sound collecting unit 100b of the headphone type sound collector 1, the sound collecting face 110a of the sound collecting cover 110 has a shape slightly curved inward like the surface of a concave mirror, as shown in FIGS. 3(a) and 3(b). As a result, sound waves, incident on the sound collecting face 110a from a direction parallel to the central axis (normal direction at the center thereof) Lc of the sound collecting face, are reflected by the sound collecting face, and the sound waves move on closer to the normal, whereby the sound is collected.

The specific shape of the sound collecting face may be any parabolic shape (shape of parabola). For example, the shape may be the shape of a portion of a spherical surface, or the shape of a portion of a parabolic shape (an offset parabolic shape, i.e., the shape of the off-center area of the parabolic shape). In addition, the shape of the sound collecting face may be other shapes, such as a concave curved surface that fits into a convex surface such as a cone or a truncated cone. The shape of the sound collecting face may further be planar, or a concave shape that is a combination of planar surfaces, for example, a shape with a concave surface that fits into a convex surface such as a pyramid or a truncated pyramid.

### (Base Member 120)

The base member 120 has a base foundation portion 120a and a base lid portion 120b.

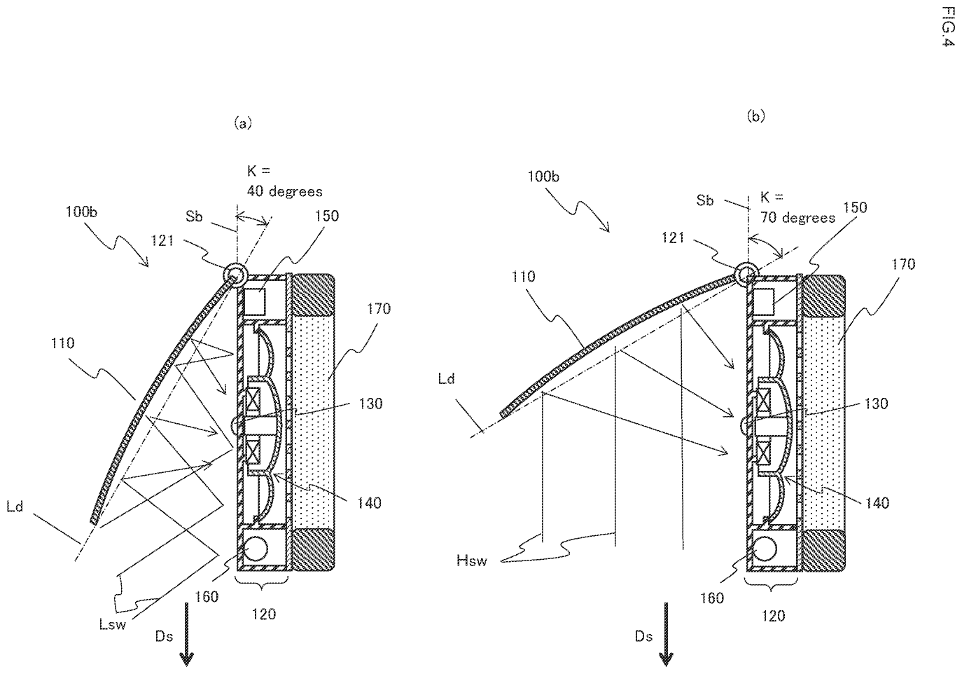

A hinge mechanism 121 for pivotally supporting the sound collecting cover 110 is attached to the base foundation portion 120a. Here, the sound collecting cover 110 is designed to pivot about the pivot axis such that the angle K formed by the surface Sb of the base member 120 and a straight line Ld connecting one end of the sound collecting cover 110 and the other end opposite to the one end thereof varies within a range of at least about zero degrees to about 90 degrees (see FIGS. 4(a) and 4(b)).

A microphone 130 is attached in substantially the center of the face on one side of the base foundation portion 120a (the face side that coordinates with the sound collecting cover 110), while a speaker 140 is housed in a parts-housing recess portion formed on the other side of the base foundation portion 120a (the side opposite to the face that coordinates with the sound collecting cover 110). Here, the speaker 140 includes a diaphragm 141, a voice coil 142, and a permanent magnet 143. The diaphragm 141 is supported on the inner peripheral surface of the parts-housing recess portion of the base foundation portion 120a; the permanent magnet 143 is attached to the bottom face of the recess portion of the base foundation portion 120a; and the voice coil 142 is attached to the diaphragm 141.

In addition, a drive circuit 150 and a battery 160 functioning as a power source of the drive circuit are mounted in the parts-housing recess portion of the base member 120. The drive circuit 150 is a circuit that drives the voice coil 142 so that the diaphragm 111 vibrates based on the audio signal output from the microphone 130 that detects sound waves, and the drive circuit is composed of an IC chip. In addition, the battery 160 may be a battery that can be repeatedly charged, or may be a disposable dry battery or button battery.

The opening of the parts-housing recess portion of the base member 120 is closed by the base lid portion 120b, and a plurality of openings 121 are formed in the base lid portion 120b to allow the sound waves generated by the speaker 140 to pass through. An ear pad member 170 is attached to the surface of the base lid portion 120b.

### (Microphone 130)

The microphone 130 is attached to the base member 120 on the side thereof closer to the sound collecting cover 110, and the microphone 130 is disposed at a position facing the center Tp of the sound collecting cover 110 when the sound collecting cover 110 is closed as shown in FIG. 3(a). The microphone 130 is connected to the drive circuit 150 of the speaker 140 so that the audio signal obtained by the detection of the sound waves is output to the drive circuit 150.

### How to Use Headphone Type Sound Collector 1

Next, how to use the headphone type sound collector 1 according to Embodiment 1 will be described.

FIG. 4 is a sectional view for illustrating how to use the headphone type sound collector 1 shown in FIG. 2, where FIGS. 4(a) and 4(b) show how sound is collected by the microphone 130 when the opening degree of the sound collecting cover 110 is about 40 degrees and about 70 degrees, respectively. It should be noted that the above angles are each merely one embodiment, and are not limited to these angles. The angles may be any angles greater than or equal to about 10 degrees.

Here, the opening degree of the sound collecting cover 110 is the angle K formed by a surface Sb of the base member 120 and a straight line Ld passing through one end of the sound collecting cover 110 and the other end opposite to the one end thereof. As the sound collecting cover 110 is opened so that the opening degree K gradually increases from about zero degrees, the frequency of the sound amplified by the headphone type sound collector 1 gradually increases. When the opening degree K of the sound collecting cover 110 is about 10 degrees, sounds up to about 1000 Hz are amplified, and when the opening degree K of the sound collecting cover 110 is about 40 degrees, the sounds of 1000 Hz to about 3000 Hz are selectively amplified (see FIG. 4(a)). Furthermore, when the sound collecting cover 110 is opened so that the opening degree K of the sound collecting cover 110 is further increased to about 70 degrees, sounds of about 3000 Hz or higher are selectively amplified (see FIG. 4(b)).

The fact that the frequency of the sound amplified by the headphone type sound collector 1 according to Embodiment 1 increases as the opening degree of the sound collecting cover 110 increases is due to a property of the sound (a property that the rectilinearity of the sound wave increases as the frequency of the sound wave increases (directivity)).

Specifically, sound waves, which are longitudinal waves that oscillate in the direction of travel, also have the property that the rectilinearity increases as the frequency increases. When the opening degree of the sound collecting cover 110 is small, the sound that enters from between the sound collecting cover 110 and the base member 120, is reflected and reverberated on the sound collecting face of the sound collecting cover 110, and reaches the microphone 130, becomes a low-frequency, low-rectilinear sound. The reason for this is as follows.

When a person is wearing the headphone type sound collector 1 of the present invention and faces the direction of the sound source, the sound Hsw, which has a high frequency and is highly rectilinear, is incident on the sound collecting cover 110 from a direction substantially parallel to the direction Ds of the sound source. Therefore, if the sound collecting cover 110 is not wide open, the sound waves entering the sound collecting cover 110 through the narrow gap between the sound collecting cover 110 and the base member 120 are reflected by the sound collecting face of the sound collecting cover 110, where most of the sound waves deviate from the microphone 130.

On the other hand, the sound Lsw, which has a low frequency and a low rectilinearity, may be incident on the sound collecting cover 110 from a direction forming a large angle with the direction of the sound source Ds even if a person wearing the headphone type sound collector 1 of the present invention faces the direction of the sound source. Thus, even if the extent of the opening of the sound collecting cover 110 is small, most of the sound reflected and reverberated by the sound collecting face of the sound collecting cover 110 reaches the microphone 130.

For this reason, when the extent of opening of the sound collecting cover 110 is small, the sounds collected and amplified by the sound collecting cover 110 are predominantly low-frequency sounds Lsw with low rectilinearity (see FIG. 4(a)). On the other hand, when the extent of opening of the sound collecting cover 110 is large, the sounds collected and amplified by the sound collecting cover 110 are predominantly high-frequency sounds Hsw with high rectilinearity for amplification (see FIG. 4(b)).

As a result, when the extent of opening of the sound collecting cover 110 is small, the low sound Lsw can be heard well, and when the extent of opening of the sound collecting cover 110 is large, the high frequency sound Hsw can be heard well. The headphone type sound collector of the present invention allows efficient collecting of frequencies that are difficult for the wearer to hear.

### Embodiment 2

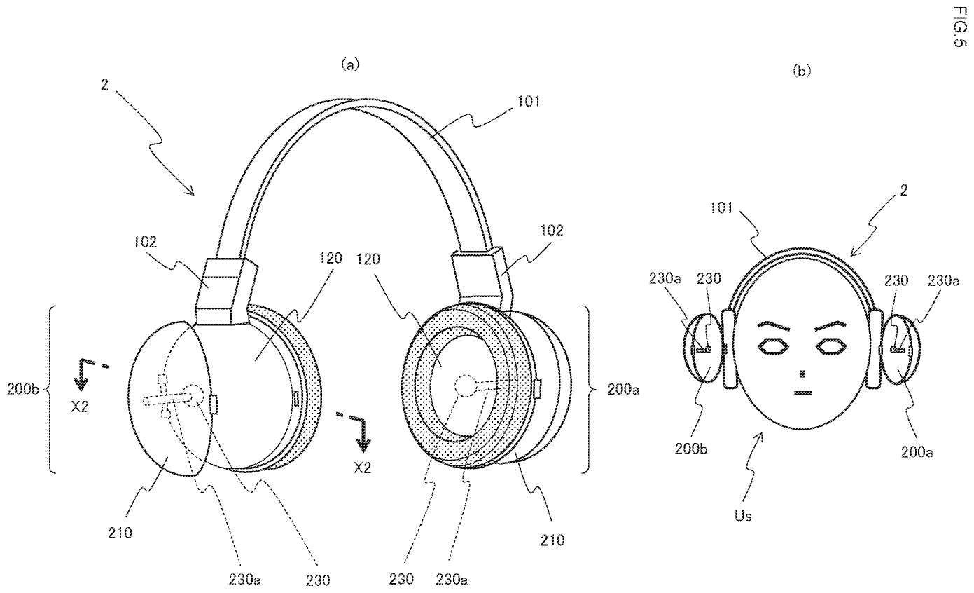

FIG. 5 is a diagram for illustrating features of a headphone type sound collector 2 according to Embodiment 2 of the present invention, where FIG. 5(a) is a perspective view showing a state in which the sound collecting cover 210 of the headphone type sound collector 2 is open, and FIG. 5(b) is a plan view of a state in which a user Us is wearing the headphone type sound collector 2 and the sound collecting cover 210 is opened, as viewed from the front of the user.

The headphone type sound collector 2 according to Embodiment 2 comprises left and right sound collecting units 200a and 200b instead of the left and right sound collecting units 100a and 100b of the headphone type sound collector 1 according to Embodiment 1. Here, the sound collecting unit 200a on the left side is the same as the sound collecting unit 200b on the right side, so in the following explanation, the sound collecting unit 200b on the right side will be described.

The sound collecting unit 200b of the headphone type sound collector 2 according to Embodiment 2 comprises a sound collecting cover 210, of which sound collecting face has an elliptical shape unlike the sound collecting cover 110 of the sound collecting unit 100b of the headphone type sound collector 1 according to Embodiment 1. In addition, instead of the microphone 130 attached to the base member 120 of the sound collecting unit 100b according to Embodiment 1, the sound collecting unit 200b comprises a microphone 230 attached to the sound collecting cover 210.

It should be noted that other configurations of the headphone type sound collector 2 according to Embodiment 2 are the same as those of the headphone type sound collector 1 according to Embodiment 1.

The sound collecting cover 210 of the headphone type sound collector 2 will be described hereinafter.

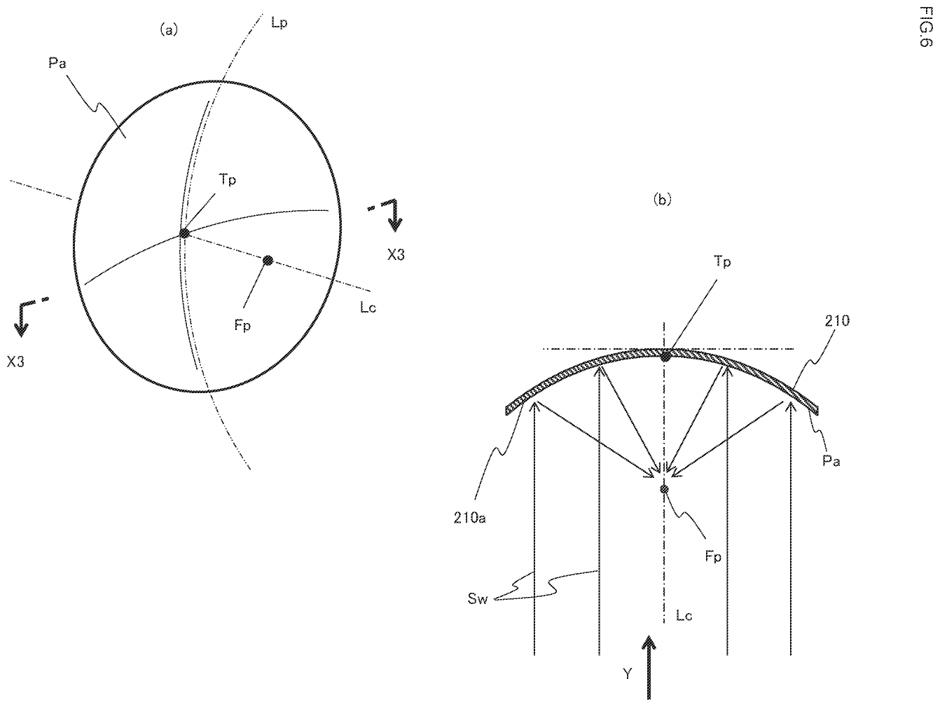

FIG. 6 is a diagram for illustrating the parabolic shape of the sound collecting cover 210 of the headphone type sound collector 2 shown in FIG. 5, where FIG. 6(a) is a perspective view showing the parabolic shape Pa, and FIG. 6(b) is a sectional view (corresponding to the line portion X3-X3) of the sound collecting cover 210 that employs the parabolic shape Pa of FIG. 6(a).

In the sound collecting unit 200b of the headphone type sound collector 2, the sound collecting face 210a of the sound collecting cover 210 has a parabolic shape Pa.

Here, the parabolic shape Pa is a shape Pa of a curved surface that is formed when a parabola Lp is rotated about the axis of symmetry Lc, as shown in FIG. 6(a). In FIG. 6(a), the following should be noted: Tp denotes the vertex of the parabolic shape Pa; Lc denotes the center line of the parabolic shape Pa; Fp denotes the focal point of the parabolic shape; the center line Lc passes through the vertex Tp of the parabolic shape; and the focal point Fp of the parabolic shape is located on the center line Lc.

As shown in FIG. 6(b), the sound collecting face 210a of the sound collecting cover 210 is a concave portion of the parabolic shape Pa, which means that sound waves Sw incident on the sound collecting face 210a from a direction parallel to the center line Lc are collected at the focal point Fp.

Hereinafter, the structure of each of the parts that constitute the headphone type sound collector 2 will be described in detail.

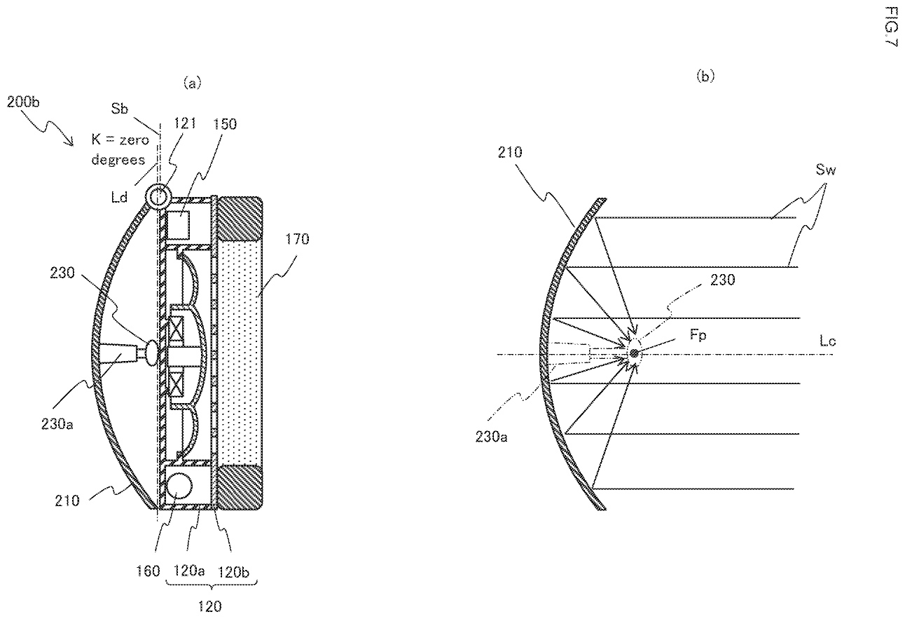

FIG. 7 is a sectional view for illustrating in detail the structure of the sound collecting unit 200b of the headphone type sound collector 2 shown in FIG. 5, where FIG. 7(a) is a sectional view taken along the line X2-X2 of FIG. 5(a), and FIG. 7 (b) shows how sound waves Sw from a direction parallel to the central axis Lc are reflected by the sound collecting cover 210 of the sound collecting unit 200b.

### (Sound Collecting Cover 210)

In the sound collecting unit 200b of the headphone type sound collector 2, as shown in FIGS. 7(a) and 7(b), the sound collecting face 210a of the sound collecting cover 210 has a parabolic shape Pa (see FIG. 6(a)). Accordingly, when sound waves incident on the sound collecting face 210a from a direction Y (not shown) parallel to the central axis (the normal direction at the center Tp thereof) Lc of the sound collecting face 210a are reflected by the sound collecting face 210a, the sound waves are focused at the focal point Fp thereof (see FIG. 7 (b)).

### (Base Member 120)

The base member 120 has a base foundation portion 120a and a base lid portion 120b, similar to the sound collecting unit 100b of the headphone type sound collector 1 according to Embodiment 1. Furthermore, a hinge mechanism. 121 for pivotally supporting the sound collecting cover 110 is attached to the base foundation portion 120a.

A speaker 140 is housed in a parts-housing recess portion of the base foundation portion 120a, and further, a drive circuit 150 for the speaker 140 and a battery 160 functioning as a power source of the drive circuit, are mounted therein.

### (Microphone 230)

In the sound collecting unit 200b of the headphone type sound collector 2, a microphone 230 is attached to the sound collecting cover 210 by an extendable microphone support 230a. When the sound collecting cover 210 is closed with respect to the base member 120, the microphone support 230a contracts due to the contact of the microphone 230 with the base member 120.

When the sound collecting cover 210 is opened to some extent and the microphone support 230a extends until the microphone 230 comes to the focal point Fp of the sound collecting face 210a of the sound collecting cover 210, the microphone support 230a does not extend further. For example, when the sound collecting cover 210 is opened to some extent (for example, the opening degrees of about 15 degrees), the microphone 230 comes to the focal point Fp of the sound collecting face 210a of the sound collecting cover 210. Note, however, that the present invention is not limited to this. For example, within the range in which sound waves can be focused, the position of the microphone may be such a position that is in a closed state by the parabolic shape.

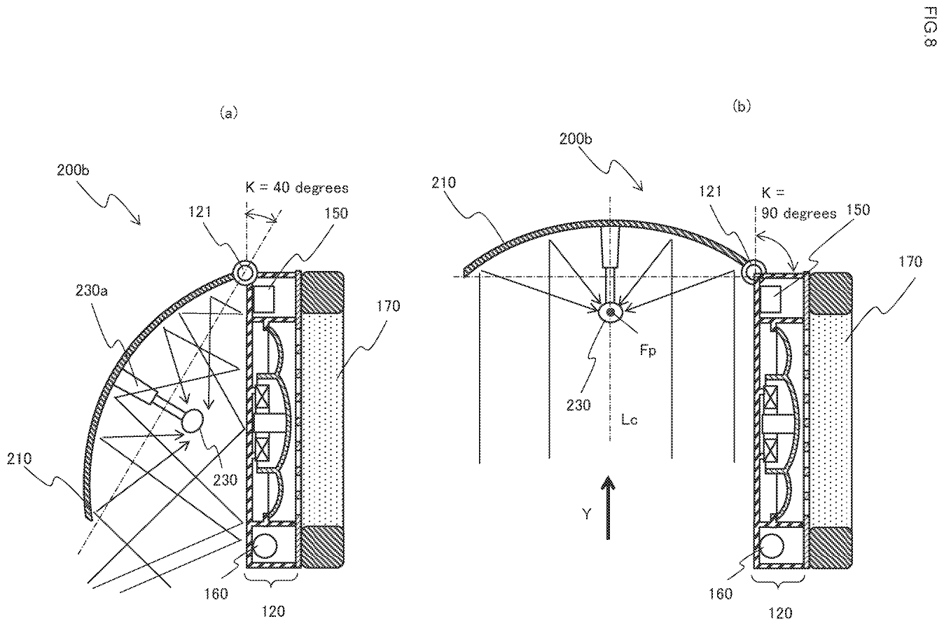

FIG. 8 is a sectional view for illustrating how to use the headphone type sound collector 2 shown in FIG. 5, where FIGS. 8(a) and 8(b) show how sound is collected by the microphone 230 when the opening degree of the sound collecting cover 210 is about 10 degrees, about 40 degrees, and about 90 degrees, respectively. However, the present invention is not limited to this. As mentioned above, the present invention is capable of collecting sound of about 1000 Hz or less at about 10 degrees, sound of about 1000 Hz to about 3000 Hz at about 40 degrees, and sound of about 3000 Hz or more at about 70 degrees. The opening degree of the sound collecting cover can be adjusted to any degree in accordance with the desired sound frequency.

In the sound collecting units 200a and 200b of the headphone type sound collector 2 according to Embodiment 2, the light collecting face 210a of the sound collecting cover 210 has a parabolic shape Pa. Because of this, the sound wave incident on the light collecting face 210a from a direction Y parallel to the central axis Lc thereof is accurately collected at the focal point Fp of the light collecting face 210a.

For example, when the opening degree K of the sound collecting cover 210 is about 40 degrees (see FIG. 8(a)), it creates a condition where sounds of about 1000 Hz to about 2000 Hz with a low rectilinearity are selectively amplified, as in the case of the headphone type sound collector 1 according to Embodiment 1. In contrast, when the opening degree is about 10 degrees, it creates a condition where sounds up to about 1000 Hz with a low rectilinearity are selectively amplified.

Meanwhile, in the case where the opening degree K of the sound collecting cover 210 is about 90 degrees (see FIG. 8(b)), sounds of about 3000 Hz or higher, which are highly rectilinear, are incident on the light collecting face 210a of the sound collecting cover 210 from a direction Y parallel to the central axis of the light collecting face 210a, with the user wearing the headphone type sound collector 2 and facing the direction of the sound source. Then, the sounds are accurately reflected toward the focal point Fc by the light collecting face 210a. Accordingly, the sounds of about 3000 Hz or higher, which are highly rectilinear, are detected by the microphone 230 with high accuracy, thereby attaining an extremely high amplification factor.

### Embodiment 3

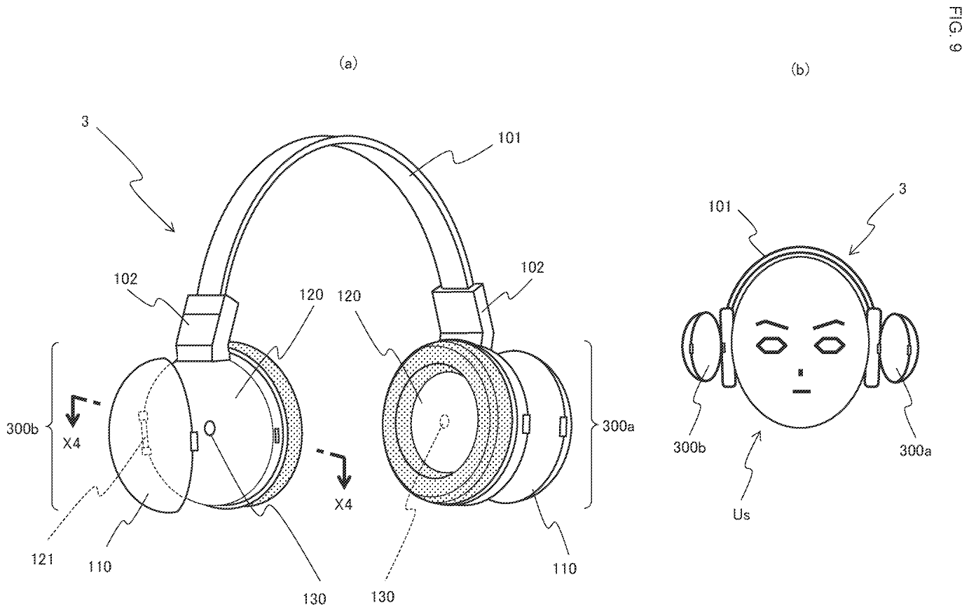

FIG. 9 is a diagram for illustrating features of a headphone type sound collector 3 according to Embodiment 3 of the present invention, where FIG. 9(a) is a perspective view showing a state in which the sound collecting cover 310 of the headphone type sound collector 3 is open, and FIG. 9(b) is a plan view of a state in which a user Us is wearing the headphone type sound collector 3 and the sound collecting cover 310 is opened, as viewed from the front of the user.

The headphone type sound collector 3 according to Embodiment 3 comprises left and right sound collecting units 300a and 300b instead of the left and right sound collecting units 200a and 200b of the headphone type sound collector 2 according to Embodiment 2. Here, the sound collecting unit 300a on the left side is the same as the sound collecting unit 300b on the right side, so in the following explanation, the sound collecting unit 300b on the right side will be described.

The sound collecting unit 300b of the headphone type sound collector 3 according to Embodiment 3 comprises a sound collecting cover 310, the sound collecting face of which has an offset parabolic shape, instead of the parabolic-shaped sound collecting cover 210 of the sound collecting unit 200b of the headphone type sound collector 2 according to Embodiment 2. In addition, instead of the microphone 230 attached to the sound collecting cover 210 of the sound collecting unit 200b according to Embodiment 2, the sound collecting unit 300b comprises a microphone 130 attached to a base member 120, similarly to the sound collecting unit 100b according to Embodiment 1.

It should be noted that other configurations of the headphone type sound collector 3 according to Embodiment 3 are the same as those of the headphone type sound collector 2 according to Embodiment 2.

The sound collecting cover 310 of the headphone type sound collector 3 will be described hereinafter.

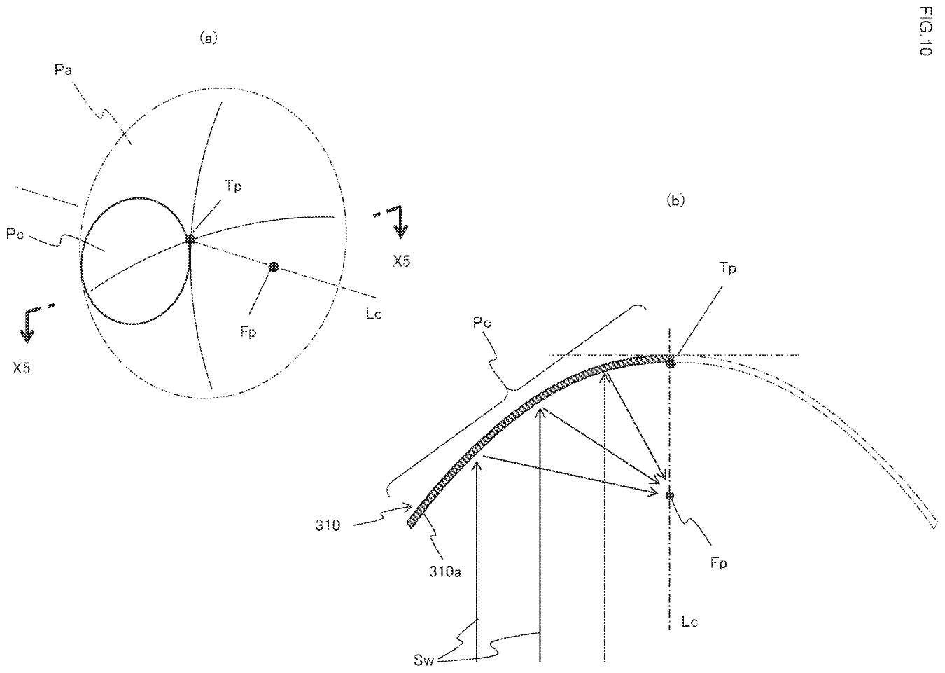

FIG. 10 is a diagram for illustrating the offset parabolic shape of the sound collecting cover 310 of the headphone type sound collector 3 shown in FIG. 9, where FIG. 10(a) is a perspective view showing an offset parabolic shape Pc, and FIG. 10(b) is a sectional view (corresponding to the line portion X5-X5) of the sound collecting cover 310 that employs the offset parabolic shape Pc of FIG. 10(a).

In the sound collecting unit 300b of the headphone type sound collector 3, the sound collecting face 310a of the sound collecting cover 310 has an offset parabolic shape Pc.

Here, the offset parabolic shape Pc is a shape Pc obtained by cutting out a part of the paraboloid (parabolic shape) Pa (see FIGS. 10(a) and 10(b)).

In FIG. 10 (a), the following should be noted: Tp denotes the vertex of the parabolic shape Pa; Lc denotes the center line of the parabolic shape Pa; Fp denotes the focal point of the offset parabolic shape Pc; the center line Lc passes through the vertex Tp of the parabolic shape Pa; and the focal point Fp of the offset parabolic shape Pc is located on the center line Lc.

As shown in FIG. 10(b), the sound collecting face 310a of the sound collecting cover 310 is a concave portion of the offset parabolic shape Pc, which means that sound waves Sw incident on the sound collecting face 310a from a direction parallel to the center line Lc are collected at the focal point Fp.

Hereinafter, the structure of each of the parts that constitute the headphone type sound collector 3 will be described in detail.

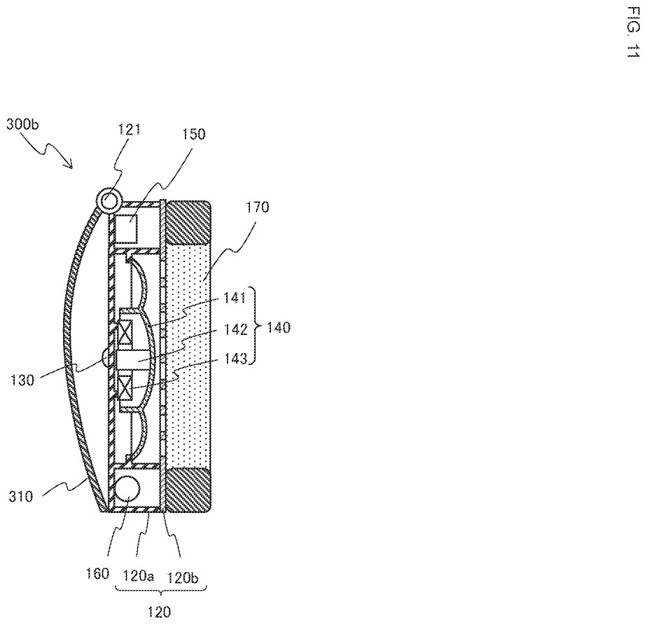

FIG. 11 is a sectional view for illustrating the structure of the sound collecting unit 300b of the headphone type sound collector 3 shown in FIG. 9, and shows the X4-X4 cross section of FIG. 9(a).

### (Sound Collecting Cover 310)

In the sound collecting unit 300b of the headphone type sound collector 3, the sound collecting face 310a of the sound collecting cover 310 has an offset parabolic shape Pc as shown in FIGS. 10(a) and 10(b). Accordingly, when sound waves Sw incident on the sound collecting face 310a from a direction parallel to the central axis (the normal direction at the center thereof) Lc of the sound collecting face are reflected by the sound collecting face 310a, the sound waves are focused at the focal point Fp thereof.

### (Base Member 120)

The base member 120 has a base foundation portion 120a and a base lid portion 120b, similar to the sound collecting unit 100b of the headphone type sound collector 1 according to Embodiment 1. Furthermore, a hinge mechanism. 121 for pivotally supporting the sound collecting cover 110 is attached to the base foundation portion 120a.

Furthermore, a speaker 140 is housed in a parts-housing recess portion of the base foundation portion 120a, and further, a drive circuit 150 for the speaker 140 and a battery 160 functioning as a power source of the drive circuit, are mounted therein.

### (Microphone 130)

In the sound collecting unit 300b of the headphone type sound collector 3, a microphone 130 is attached to the base member 120, similarly to the microphone 130 of the sound collecting unit 100b of the headphone type sound collector 1 according to Embodiment 1.

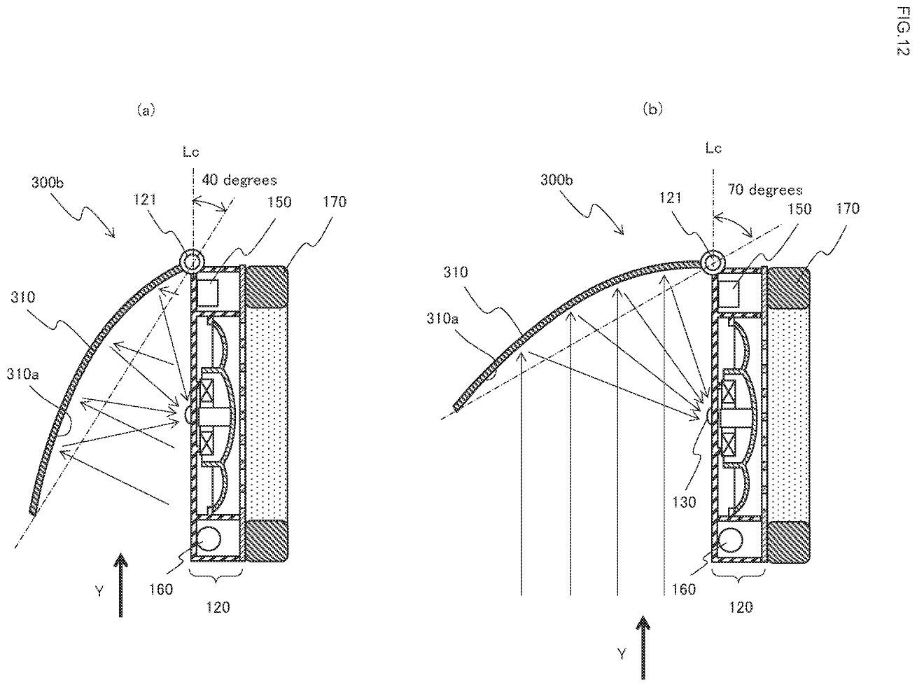

FIG. 12 is a sectional view for illustrating how to use the headphone type sound collector 3 shown in FIG. 9, where FIGS. 12(a) and 12(b) show how sound is collected by the microphone 130 when the opening degree of the sound collecting cover 310 is about 40 degrees and about 70 degrees, respectively.

In the sound collecting units 300a and 300b of the headphone type sound collector 3 according to Embodiment 3, the light collecting face 310a of the sound collecting cover 310 has an offset parabolic shape Pc. Because of this, when the central axis Lc of the offset parabolic shape Pc is parallel to the incoming direction Y of the sound wave, the sound wave incident on the light collecting face 310a is accurately collected at the focal point Fp (that is, the position where the microphone 130 is disposed) of the light collecting face 310a.

For example, when the opening degree K of the sound collecting cover 310 is about 40 degrees (see FIG. 12(a)), it creates a condition where sounds of about 1000 Hz to about 2000 Hz with a low rectilinearity are selectively amplified, as in the case of the headphone type sound collector 2 according to Embodiment 2.

Meanwhile, in the case where the opening degree K of the sound collecting cover 310 is about 70 degrees (where the incoming direction of the sound wave is parallel to the central axis Lc of the offset parabolic shape Pc) (see FIG. 12(b)), sounds of about 3000 Hz or higher, which are highly rectilinear, are incident on the light collecting face 310a of the sound collecting cover 310 from a direction Y parallel to the central axis Lc of the light collecting face 310a. Then, the sounds are accurately reflected toward the focal point Fc (the position at which the microphone 130 is attached) by the light collecting face 310a. Accordingly, the sounds of about 4000 Hz or higher, which are highly rectilinear, are detected by the fixed microphone 130 with high accuracy, whereby such a simple structure attains an extremely high amplification factor.

As described above, the present invention has been exemplified with preferred embodiments of the present invention, but the present invention should not be interpreted to be limited to the embodiments. It is understood that the scope of the present invention should be interpreted based solely on the Claims. It is understood that those skilled in the art can implement an equivalent scope from the descriptions of the specific preferred embodiments of the present invention based on the description of the present invention and common general knowledge. It is understood that any references cited herein should be incorporated herein by reference in the same manner as the contents are specifically described herein.

### INDUSTRIAL APPLICABILITY

The present invention is useful as an invention which can provide a headphone type sound collector capable of selectively amplifying frequencies of sounds that are difficult for people with weak hearing to hear.

### REFERENCE SIGNS LIST

1 to 3: headphone type sound collector
100a, 100b, 200a, 200b, 300a, 300b: sound collecting unit
101: head band
102: connector
110, 210, 310: sound collecting cover
110a, 210a, 310a: sound collecting cover
120: base member
120a: base foundation portion
120b: base lid portion
121: hinge mechanism
130, 230: microphone
140: speaker
141: diaphragm
142: voice coil
143: permanent magnet
150: drive circuit
160: battery
170: ear pad member
230a: extendable microphone support
Fp: focal point of parabolic shape
Lc: central axis of parabolic shape

1. A headphone type sound collector equipped with a sound collecting device on at least either of the left and right sides thereof, the sound collecting device comprising:
a sound collecting cover having a sound collecting face in a parabolic shape for collecting sound;
a base member for pivotally supporting the sound collecting cover; and
a microphone for detecting sound collected by the sound collecting cover.

2. The headphone type sound collector according to claim 1, wherein the sound collecting cover has a sound collecting face in the shape of a portion offset from the center of the parabolic shape.

3. The headphone type sound collector according to claim 1, wherein the microphone is fixed to the base member.

4. The headphone type sound collector according to claim 1, wherein the microphone is attached to the sound collecting cover.

5. The headphone type sound collector according to claim 1, wherein the base member supports one end of the sound collecting cover such that the sound collecting cover pivots about a pivot axis substantially parallel to upward and downward directions of the headphone type sound collector.

6. The headphone type sound collector according to claim 5, wherein the sound collecting cover pivots about the pivot axis such that the angle formed by a surface of the base member and a straight line connecting one end of the sound collecting cover and the other end opposite to the one end thereof varies within a range of about zero degrees to about 90 degrees.

7. The headphone type sound collector according to claim 1, wherein at least either of the pair of left and right sound collecting devices comprises:
an amplifier circuit for amplifying an audio signal detected by the microphone; and
a speaker driven by the audio signal amplified by the amplifier circuit.
